(19) United States
(12) Patent Application Publication
(10) Pub. No.: US 2006/0294144 A1
(43) Pub. Date: Dec. 28, 2006

(54) IMAGE FORMING APPARATUS AND IMAGE FORMING METHOD THEREOF

(76) Inventor: Sung-ryong SHIN, Anyang-si (KR)

Correspondence Address: STANZIONE & KIM, LLP, 919 18TH STREET, N.W., SUITE 440, WASHINGTON, DC, 20006, US

(21) Appl. No.: 11/426,041

(22) Filed: Jun. 23, 2006

(30) Foreign Application Priority Data
Jun. 23, 2005 (KR) 2005-54375

(51) Int. Cl. G06F 7/00

(52) U.S. Cl. 707/104.1

(57) ABSTRACT

An image forming apparatus includes a host to generate and to output metadata, and a peripheral device to form an image using the metadata.

### CROSS-REFERENCE TO RELATED APPLICATIONS

This application claims priority under 35 U.S.C. §119(a) from Korean Patent Application No. 10-2005-0054375, filed on Jun. 23, 2005, in the Korean Intellectual Property Office, the disclosure of which is incorporated herein in its entirety by reference.

### BACKGROUND OF THE INVENTION

1. Field of the Invention

The present general inventive concept relates to an image forming apparatus, and more particularly, to an image forming apparatus to receive generated metadata from a host without converting the generated metadata in the host, to generate image data in which a pixel value for each pixel is indicated according to contents of the received metadata, and having a peripheral device to form an image corresponding to the generated image data, and an image forming method thereof.

2. Description of the Related Art

A printing device, such as a printer or a multi function peripheral (MFP) having a print function, uses the following process to print print data received from a host, such as a personal computer (PC).

The host generates metadata according to a command of a user using an application program. Here, a graphic device interface (GDI) in the host analyzes the metadata and transmits print-related information contained in the metadata to a driver. The driver is included in the host and is unique for every print device connected to the host.

The driver generates print data by converting the metadata to data of a language intelligible to firmware of the printing device, according to the print-related information, and transmits the print data to the printing device via a spooler. Here, the firmware of the printing device which receives the print data generates image data by converting the print data to data intelligible to the printing device, and prints the image data.

For a conventional image forming apparatus to print metadata, the host must transmit print data generated by converting the metadata to a printing device, and cannot simply transmit the metadata itself to the printing device. The printing device can only convert the print data to image data, and cannot convert the meta data to image data. Thus, there are limits to increasing a printing speed of a conventional image forming apparatus. In addition, the conventional image forming apparatus cannot print the metadata using a printing device of the image forming apparatus if a unique driver for the printing device is not present in a host of the image forming apparatus.

### SUMMARY OF THE INVENTION

The present general inventive concept provides an image forming apparatus to receive metadata from a host without converting the metadata in the host, to generate image data in which a pixel value for each pixel is indicated according to contents of the metadata, and having a peripheral device to form an image corresponding to the image data.

The present general inventive concept also provides an image forming method of receiving metadata from a host without converting the metadata in the host, generating in a peripheral device image data in which a pixel value for each pixel is indicated according to contents of the metadata, and forming an image corresponding to the image data.

The present general inventive concept also provides a computer readable recording medium storing a computer readable program to perform a method of receiving metadata from a host without converting the metadata in the host, generating in a peripheral device image data in which a pixel value for each pixel is indicated according to contents of the metadata, and forming an image corresponding to the image data.

Additional aspects and advantages of the present general inventive concept will be set forth in part in the description which follows and, in part, will be obvious from the description, or may be learned by practice of the general inventive concept.

The foregoing and/or other aspects and utilities of the present general inventive concept may be achieved by providing an image forming apparatus including a host to generate and to output metadata, and a peripheral device to form an image using the metadata.

The peripheral device may include an image data generator to generate image data according to the contents of the metadata output by the host, an image forming unit to form an image corresponding to the image data under the control of a print control signal, and a controller to generate the print control signal to control the image forming unit to form commanding that an the image of corresponding to the image data.

The image data generator may include an interpreting unit to interpret the metadata; and a converting unit to generate the image data using the result of the interpretation. The image forming unit may form the image by printing the image data.

The host may include a metadata generator to generate the metadata; and a metadata delivering unit to deliver the generated metadata to the peripheral device to form the image using the delivered metadata.

The host may further include an analyzing unit to analyze a size of the generated metadata, and a metadata compressing unit to compress the generated metadata in response to the analysis result of the analyzing unit, and the metadata delivering unit may deliver the compressed metadata to the peripheral device.

The metadata delivering unit may be implemented on a driver installed in the host or a virtual driver.

The foregoing and/or other aspects and utilities of the present general inventive concept may also be achieved by providing an image forming method including generating metadata in a host and delivering the generated metadata from the host, and forming an image using the delivered metadata in a peripheral device connected to the host.

The generating and delivering of the metadata may include generating the metadata in the host and determining whether a size of the generated metadata is greater than a pre-set threshold size, if it is determined that the size of the generated metadata is greater than the pre-set threshold size, compressing the generated metadata, and delivering the generated metadata or the compressed metadata form the host to the peripheral device.

The forming of the image may include generating image data according to contents of the delivered metadata, and forming an image using the generated image data.

The generating of the image data may include interpreting the delivered metadata, and generating the image data using the result of the interpretation. The image may be formed by printing the image data.

The foregoing and/or other aspects and utilities of the present general inventive concept may also be achieved by providing a computer readable recording medium storing a computer readable program to perform an image forming method, the method including generating metadata in a host and delivering the generated metadata from the host, and forming an image using the metadata in a peripheral device connected to the host.

The foregoing and/or other aspects and utilities of the present general inventive concept may also be achieved by providing an image forming apparatus, including a printing unit to generate print data using received metadata, and a host unit to generate the metadata and to transfer the metadata to the printing unit.

The host unit may include a processing unit to determine whether a size of the generated metadata is greater than a predetermined size, and to compress the generated metadata and transfer the compressed metadata to the printing unit when the processing unit determines that the size of the metadata is greater than the predetermined size. The host unit may further include a driver to transfer the generated metadata the printing unit. The driver may be a virtual driver or driver installed in the host.

The foregoing and/or other aspects and utilities of the present general inventive concept may also be achieved by providing an image forming apparatus, including a host device useable with a printing device, the host device including a generating unit to generate metadata, and a transfer unit to transfer the metadata to the printing device.

The foregoing and/or other aspects and utilities of the present general inventive concept may also be achieved by providing an image forming apparatus, including a printing device useable with a host device, the printing device including a converting unit to convert metadata received from the host device into print data, and a printing unit to print using the print data.

The foregoing and/or other aspects and utilities of the present general inventive concept may also be achieved by providing a method of generating print data to be printed by a printing apparatus, the method including transferring metadata generated in a host apparatus from the host apparatus to the printing apparatus, and generating the print data by converting the transferred metadata into the print data in the printing apparatus.

The method may further include generating the metadata in the host apparatus. The method may further include printing the print data generated in the printing apparatus. The transferring of the metadata may include transferring the metadata from a driver of the host apparatus to the printing apparatus. The driver may be a virtual driver or a driver installed in the host. The driver may be the driver installed in the host, and the transferring of the metadata may further include setting registration information in the driver to transfer the metadata from the host apparatus to the printing apparatus. The transferring of the metadata may include determining whether a size of the generated metadata is greater than a predetermined size, compressing the generated metadata and transferring the compressed metadata to the printing apparatus when the size of the metadata is greater than the predetermined size, and transferring the generated metadata without compressing the generated metadata when the size of the metadata is less than or equal to the predetermined size.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a reference diagram illustrating an image forming apparatus, according to an embodiment of the present general inventive concept;

FIG. 2A is a block diagram illustrating an image forming apparatus, according to an embodiment of the present general inventive concept;

FIG. 2B is a reference diagram illustrating an interface of the image forming apparatus of FIG. 2A, according to an embodiment of the present general inventive concept;

FIG. 3 is a flowchart illustrating an image forming method performed in a host illustrated in FIG. 2A, according to an embodiment of the present general inventive concept; and

FIG. 4 is a flowchart illustrating an image forming method performed in a peripheral device illustrated in FIG. 2A, according to an embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

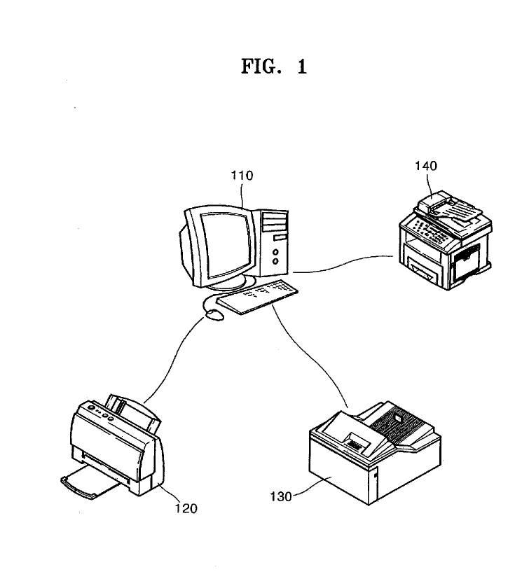

FIG. 1 is a reference diagram illustrating an image forming apparatus, according to an embodiment of the present general inventive concept. The image forming apparatus includes a host device 110 (hereafter referred to as a host 110) and peripheral devices 120, 130, and 140. Here, the peripheral devices 120,130, and 140 include a printing device A 120, a printing device B 130, and a printing device C 140.

The host 110 can be, for example, a PC (personal computer), and each of the printing devices A 120 through C 140 can be an MFP (multi function peripheral) having a print function. For example, the printing device A 120 can be an ink-jet printer, the printing device B 130 can be a laser beam printer (LBP), and the printing device C 140 can be an MFP having a print function. Various types and models of peripheral devices can be connected to the host 110. For example, various models of LBPs can be connected simultaneously to the host 110.

A conventional host needs drivers corresponding to connected peripheral devices to perform printing through the connected peripheral devices. Since the drivers differ according to a type and model of the peripheral devices, for the conventional host to print through a printing device, a driver of the printing device must be installed in the conventional host.

However, the image forming apparatus according to this embodiment of the present general inventive concept prints metadata through a peripheral device connected to the host 110, even if a driver of the peripheral device is not installed in the host 110.

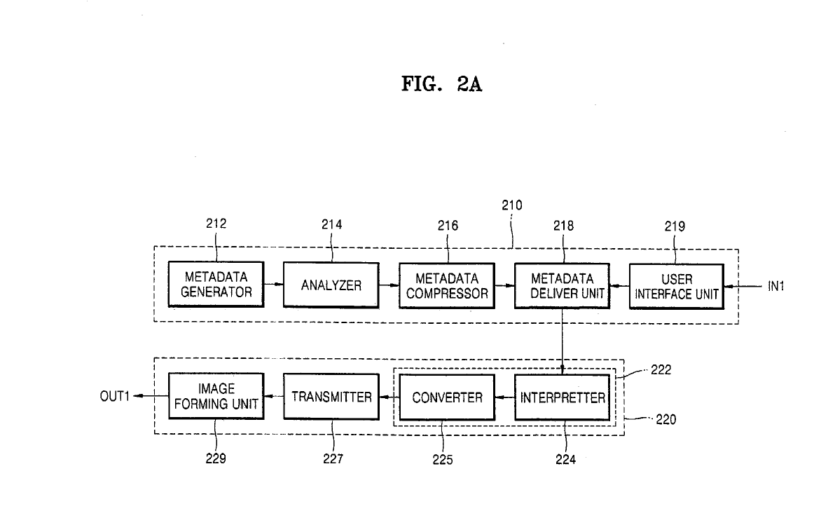

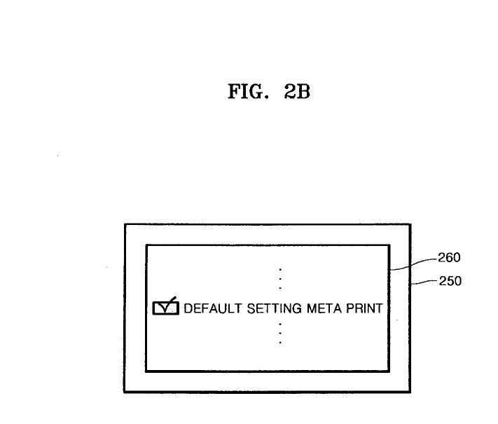

FIG. 2A is a block diagram illustrating an image forming apparatus, according to an embodiment of the present general inventive concept. The image forming apparatus includes a host 210 and a peripheral device 220. The host 210 can include a metadata generator 212, an analyzer 214, a metadata compressor 216, a metadata deliver unit 218, and a user interface unit 219. The peripheral device 220 can include an image data generator 222 having an interpreter 224 and a converter 225, a transmitter 227, a controller (not illustrated), and an image forming unit 229.

The metadata generator 212 can generate metadata when a user works with an application program in the host 210 through the user interface unit 219.

The application program can be, for example, a word processing program, such as Microsoft® Word, or a graphics processing program, such as Adobe® Photoshop®. If the application program is a word processing program, the metadata is text data, and if the application program is a graphics processing program, the metadata is image data.

Likewise, the metadata is generated when an application program is run, and if the host 210 uses a Microsoft® Windows operating system (OS), the generated metadata can be contained in a file having an Enhanced Meta File (EMF) extension. Thus, the metadata can be called a meta file.

As described above, when such metadata is to be printed by a conventional image forming apparatus, instead of transmitting the metadata to a peripheral device (such as a printer), print data is generated by converting the metadata according to a predetermined printer command and transmitted to the peripheral device (such as a printer). To convert the metadata, the host needs a driver for the peripheral device through which printing is performed. The driver converts the metadata to the print data.

However, according to the present embodiment, the metadata does not have to be converted to print data in the host 210, and the host 210 directly transmits the metadata to the peripheral device 220. Here, the host 210 can transmit the metadata with or without compressing it. If a size of the metadata is greater than a threshold size, the host 210 may transmit the metadata after compressing the metadata. To compress the metadata, the host 210 may include the analyzer 214 and the metadata compressor 216. However, in embodiments, the host 210 does not include the analyzer 214 and the metadata compressor 216 to compress the metadata.

The analyzer 214 analyzes the size of the metadata generated by the metadata generator 212. More specifically, the analyzer 214 compares the size of the metadata with the threshold size. The threshold size may be a pre-set threshold size.

The metadata compressor 216 can compress the metadata when the size of the metadata is determined to be greater than the threshold size. The compressed metadata is transmitted to the metadata deliver unit 218.

If it is determined that the size of the metadata is equal to or less than the threshold size, the metadata compressor 216 may not compress the metadata. In this case, the metadata compressor 216 transmits the metadata to the metadata deliver unit 218 without compressing the metadata.

The metadata deliver unit 218 delivers the generated metadata or the compressed metadata to the peripheral device 220. In more detail, the metadata compressor 216 inputs metadata to the metadata deliver unit 218. The metadata deliver unit 218 outputs the compressed metadata if the metadata compressor 216 has compressed the input metadata. On the other hand, the metadata deliver unit 218 outputs the uncompressed generated metadata if the metadata compressor 216 has input the uncompressed generated metadata to the metadata deliver unit 218. The output metadata is delivered to the interpreter 224 of the peripheral device 220.

The metadata deliver unit 218 can be implemented on an arbitrary driver (e.g., an existing driver) already installed in the host 210, or a driver (e.g., a virtual driver) newly installed in the host 210.

The existing driver is a driver in the host 210 corresponding to a peripheral device through which metadata is printed. The existing driver may be a driver installed in a conventional host. To implement the metadata deliver unit 218 on the existing driver in the host 210, register information of the existing driver should be set so that a spooler prepared in the host 210 spools metadata instead of print data.

FIG. 2B is a reference diagram illustrating an interface 250 of the image forming apparatus of FIG. 2A, according to an embodiment of the present general inventive concept. As illustrated in FIG. 2B, using various types of register information displayed on a register information setting interface 260 included in the interface 250 of the existing driver in the host 210, the user may ensure that desired register information is set so that the spooler in the host 210 spools the metadata. For example, by activating “default setting meta print” register information by checking “default setting meta print” on the register information setting interface 260, the user can set the register information so that the spooler in the host 210 spools the metadata.

Referring to FIG. 2A, the user interface unit 219 selects whether the host 210 transmits the metadata to the peripheral device 220 using the metadata deliver unit 218 implemented on the existing driver or the virtual driver of the host 210. In FIG. 2A, IN1 denotes a selection (e.g., IN1 is a selection to transmit the metadata to the peripheral device 220 using the metadata deliver unit 218).

The metadata transmitted to the peripheral device 220 is transmitted from a spooler in the metadata deliver unit 218, and the transmission can be called spooling. That is, data spooled to the peripheral device 220 through the spooler in the metadata deliver unit 218 is metadata for the image forming apparatus according to this embodiment of the present general inventive concept. In contrast, data spooled to a peripheral device in a conventional image forming apparatus is print data (i.e., print data corresponding to converted metadata) and not metadata.

The virtual driver is separate from the existing driver in the host 210, and does not convert the metadata to print data, but instead transmits the metadata or the compressed metadata to the peripheral device 220. The virtual driver can be referred to as a new driver.

The peripheral device 220 forms an image corresponding to the transmitted metadata. According to embodiments of the present general inventive concept, the peripheral device 220 receives only the metadata or the compressed metadata.

The image data generator 222 generates image data by parsing the transmitted metadata. Here, parsing means analyzing. In more detail, the image data generator 222 generates image data according to contents of the transmitted metadata. In general, the transmitted metadata has a format unintelligible to the peripheral device 220, and the image data generator 222 generates image data by converting the transmitted metadata to print data. Here, the image data contains the contents of the metadata and has a format intelligible to peripheral device 220.

In more detail, the interpreter 224 of the image data generator 222 extracts print-related information contained in the delivered metadata by interpreting the delivered metadata (delivered from the metadata deliver unit 218).

The print-related information, which relates to how the metadata is printed on a printing medium (e.g., paper), is contained in the metadata. For example, the print-related information can be information regarding a color for each position on the printing medium (e.g., paper) on which the metadata is printed.

The converter 225 of the image data generator 222 generates image data representing a pixel value for each pixel using the result of the interpretation (i.e., the result of the analysis of the metadata by the interpreter 224). Accordingly, the converter 225 converts the delivered and interpreted metadata into the image data.

The transmitter 227 of the peripheral device 220 transmits the image data to the image forming unit 229. The interpreter 224, the converter 225, and the transmitter 227 may be implemented in firmware of the peripheral device 220.

The image forming unit 229 forms an image corresponding to the transmitted image data. For example, the image forming unit 229 may form the image by printing the transmitted image data. In FIG. 2A, OUT1 can denote the formed image or the print results. The image forming unit 229 may operate under the control of the controller (not illustrated) in the peripheral device 220. The controller controls the image forming unit 229 to form an image of the transmitted image data.

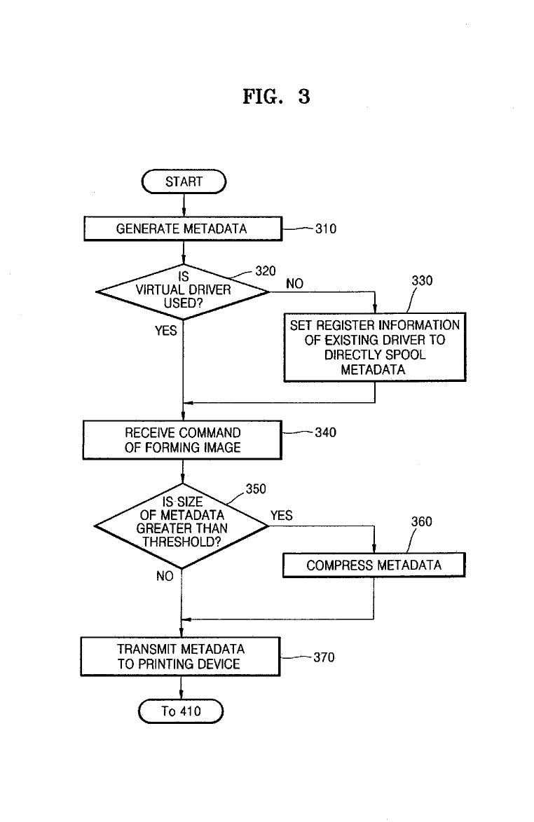

FIG. 3 is a flowchart illustrating an image forming method performed in the host 210 illustrated in FIG. 2A, according to an embodiment of the present general inventive concept. The image forming method includes generating metadata in the metadata generator 212 and transmitting the generated metadata to the peripheral device 220 (operations 310 through 370).

Referring to FIGS. 2-3, in operation 310, the metadata generator 212 generates the metadata. In operation 320, the host 210 receives a control signal indicating whether the host 210 should use the virtual driver through the user interface unit 219.

If the host 210 receives a control signal not to use the virtual driver in operation 320, the host 210 receives register information of the existing driver (i.e., the driver installed in the host 210) through the user interface unit 219 so that the metadata deliver unit 218 delivers the metadata to the peripheral device 220 in operation 330, and the process proceeds to operation 340. On the other hand, if the host 210 receives a control signal to use the virtual driver in operation 320, the process proceeds to operation 340.

In operation 340, the host 210 receives a control signal from the user to print the metadata. In operation 350, the analyzer 214 determines whether a size of the metadata is greater than a pre-set threshold size.

If it is determined that the size of the metadata is greater than the pre-set threshold size, then the metadata compressor 216 compresses the metadata in operation 360 and transmits the compressed metadata to the metadata deliver unit 218.

If it is determined that the size of the metadata is equal to or less than the pre-set threshold size, the metadata compressor 216 transmits the uncompressed metadata to the metadata deliver unit 218.

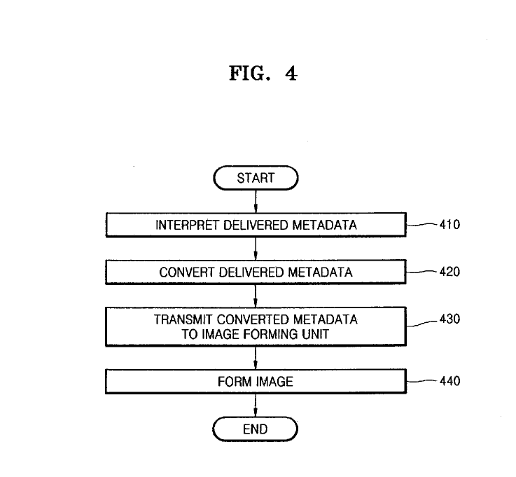

In operation 370, the metadata deliver unit 218 transmits the metadata or the compressed metadata to the peripheral device 220. Then the process proceeds to an operation 410, as described below with reference to FIG. 4.

FIG. 4 is a flowchart illustrating an image forming method performed in the peripheral device 220 illustrated in FIG. 2A, according to an embodiment of the present general inventive concept. The image forming method includes generating image data by interpreting and converting the metadata in the image data generator 222 (operations 410 and 420), transmitting the generated image data to the image forming unit 229 through the transmitter 227, and forming an image corresponding to the transmitted image data using the image forming unit 229 (operations 430 and 440).

Referring to FIG. 4, in operation 410, the interpreter 224 interprets the delivered metadata delivered from the metadata deliver unit 218. In operation 420, the converter 225 generates the image data by reflecting the result of the interpretation (i.e., the result of the analysis of the metadata by the interpreter 224) and converting the delivered and interpreted metadata into data intelligible to the peripheral device 220.

In operation 430, the transmitter 227 transmits the image data to the image forming unit 229. In operation 440, the image forming unit 229 forms an image represented by the image data by printing the image data.

The present general inventive concept may be embodied in a general-purpose computer by running a program from a computer-readable medium, including but not limited to storage media such as magnetic storage media (ROMs, RAMs, floppy disks, magnetic tapes, etc.), optically readable media (CD-ROMs, DVDs, etc.), and carrier waves (transmission over the internet). The present general inventive concept may be embodied as a computer-readable medium having a computer-readable program code unit embodied therein for causing a number of computer systems connected via a network to effect distributed processing. The functional programs, code and code segments for embodying the present general inventive concept may be easily construed by programmers skilled in the art to which the present general inventive concept belongs.

According to embodiments of the present general inventive concept, in an image forming apparatus and image forming method thereof, since a host transmits unconverted metadata to a peripheral device (e.g., a printer) instead of converting the metadata to print data using a printer command and then transmitting the print data generated by the host to the peripheral device, time taken by the host can be reduced when the metadata is printed. In addition, and since the metadata (and not the print data converted using the printer command) is transmitted to the peripheral device, the peripheral device does not have to analyze the printer command constructing the print data and convert the print data to data intelligible to the peripheral device as in a conventional image forming apparatus. Thus, time taken by the peripheral device can also be reduced when the metadata is printed. That is, since the time taken by the host and the peripheral device to print can be reduced compared to a conventional image forming apparatus, printing can be performed at a higher speed.

Furthermore, if the peripheral device can analyze the metadata generated by the host, to generate image data and a pixel value for each pixel, and can form an image represented by the image data, the host can transmit the metadata generated by the host to the peripheral device without converting the metadata to print data using a printer command, and the host does not need unique drivers for each peripheral device connected to the host. Accordingly, each peripheral device connected to the host can print the metadata even though the host does not have a unique driver for each peripheral device.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An image forming apparatus, comprising:
a host to generate and to output metadata; and
a peripheral device to form an image using the metadata output by the host.

2. The apparatus of claim 1, wherein the peripheral device comprises:
an image data generator to generate image data by parsing the metadata output by the host;
an image forming unit to form the image corresponding to the image data under the control of a print control signal; and
a controller to generate the print control signal to control the image forming unit to form the image corresponding to the image data.

3. The apparatus of claim 2, wherein the image data generator comprises:
an interpreting unit to interpret the metadata; and
a converting unit to generate the image data using the result of the interpretation.

4. The apparatus of claim 1, wherein the host comprises:
a metadata generator to generate the metadata; and
a metadata delivering unit to deliver the generated metadata to the peripheral device to form the image using the delivered metadata.

5. The apparatus of claim 4, wherein the host further comprises:
an analyzing unit to analyze a size of the generated metadata; and
a metadata compressing unit to compress the generated metadata in response to the analysis result of the analyzing unit,
wherein the metadata delivering unit delivers the compressed metadata to the peripheral device.

6. The apparatus of claim 5, wherein the metadata delivering unit is implemented on a driver installed in the host or a virtual driver.

7. An image forming apparatus, comprising:
a printing unit to generate print data using received metadata; and
a host unit to generate the metadata and to transfer the metadata to the printing unit.

8. The image forming apparatus of claim 7, wherein the host unit comprises:
a processing unit to determine whether a size of the generated metadata is greater than a predetermined size, and to compress the generated metadata and transfer the compressed metadata to the printing unit when the processing unit determines that the size of the metadata is greater than the predetermined size.

9. The image forming apparatus of claim 7, wherein the host unit further comprises:
a driver to transfer the generated metadata the printing unit.

10. The image forming apparatus of claim 9, wherein the driver is a virtual driver or driver installed in the host.

11. An image forming apparatus, comprising:
a host device useable with a printing device, the host device comprising:
a generating unit to generate metadata, and
a transfer unit to transfer the metadata to the printing device.

12. An image forming apparatus, comprising:
a printing device useable with a host device, the printing device comprising:
a converting unit to convert metadata received from the host device into print data, and
a printing unit to print using the print data.

13. A method of generating print data to be printed by a printing apparatus, the method comprising:
transferring metadata generated in a host apparatus from the host apparatus to the printing apparatus; and
generating the print data by converting the transferred metadata into the print data in the printing apparatus.

14. The method of claim 13, further comprising:
generating the metadata in the host apparatus.

15. The method of claim 13, further comprising:
printing the print data generated in the printing apparatus.

16. The method of claim 13, wherein the transferring of the metadata comprises:
transferring the metadata from a driver of the host apparatus to the printing apparatus.

17. The method of claim 16, wherein the driver is a virtual driver or a driver installed in the host.

18. The method of claim 17, wherein the driver is the driver installed in the host, and the transferring of the metadata further comprises:
setting registration information in the driver to transfer the metadata from the host apparatus to the printing apparatus.

19. The method of claim 13, wherein the transferring of the metadata comprises:
determining whether a size of the generated metadata is greater than a predetermined size;
compressing the generated metadata and transferring the compressed metadata to the printing apparatus when the size of the metadata is greater than the predetermined size; and
transferring the generated metadata without compressing the generated metadata when the size of the metadata is less than or equal to the predetermined size.
